(19) United States
(12) Patent Application Publication
(10) Pub. No.: US 2001/0034681 A1
(43) Pub. Date: Oct. 25, 2001

(54) Methods and systems for financing and executing transactions

(76) Inventors: Preston H. Abbott, Guilford, CT (US); Joseph W. Krum, High Point, NC (US)

Correspondence Address: John S. Beulick, Armstrong Teasdale LLP, One Metropolitan Square, Suite 2600, St. Louis, MO, 63102-2740, US

(21) Appl. No.: 09/769,121

(22) Filed: Jan. 24, 2001

Related U.S. Application Data
(60) Provisional application No. 60/178,090, filed on Jan. 26, 2000.

(51) Int. Cl. G06F 17/60

(52) U.S. Cl. 705/35

(57) ABSTRACT

Methods and systems for executing and financing transactions of goods and commodities as an insulated parent company are described. The method includes the steps of incorporating wholly owned subsidiary companies to handle trading and financing issues, approving sellers to participate according to a seller participation agreement, approving buyers to participate according to a buyer participation agreement, and securing capital to facilitate financing through a financing subsidiary.

### CROSS REFERENCE TO RELATED APPLICATIONS

This application claims the benefit of U.S. Provisional Application No. 60/178,090, filed Jan. 26, 2000, which is hereby incorporated by reference in its entirety.

### BACKGROUND OF THE INVENTION

This invention relates generally to methods of doing business and more specifically to insulating a parent company acting as a medium through which buyers and sellers transact business from the disputes or claims of buyers and sellers through the incorporation of subsidiaries.

The increase of business conducted over the internet has caused an increase in business opportunities for both entrepreneurs and established corporations alike, in what has become known as E-commerce. A portion of the internet activity is the buying, selling and auctioning of commodities or other goods through companies, referred to as “dot corn” companies. “Dot com” companies are available to a potential customer twenty four hours a day, seven days a week, from anywhere in the world.

Unfortunately, the entrepreneur who sees an opportunity in a market niche for E-commerce, may not be an expert in that particular business where he or she perceives the niche, and may be exposing themselves to liability claims or other causes of action. It would be desirable to enable a “dot com” company to facilitate the buying and selling of goods without incurring the liability risk associated with known methods of buying and selling of goods.

### BRIEF SUMMARY OF THE INVENTION

A business model including a method for executing and financing transactions of goods and commodities as a parent company is described. The method of implementing the business model includes the steps of incorporating wholly owned subsidiary companies to handle trading and financing issues, approving sellers to participate according to a seller participation agreement, approving buyers to of implementing the business model includes the steps of incorporating wholly owned subsidiary companies to handle trading and financing issues, approving sellers to participate according to a seller participation agreement, approving buyers to participate according to a buyer participation agreement and securing capital to facilitate financing through a financing subsidiary.

### BRIEF DESCRIPTION OF THE DRAWINGS

FIG. 1 is a system block diagram; and

FIG. 2 is a chart of a business model showing transactions and paths of the transactions according to the present invention.

### DETAILED DESCRIPTION OF THE INVENTION

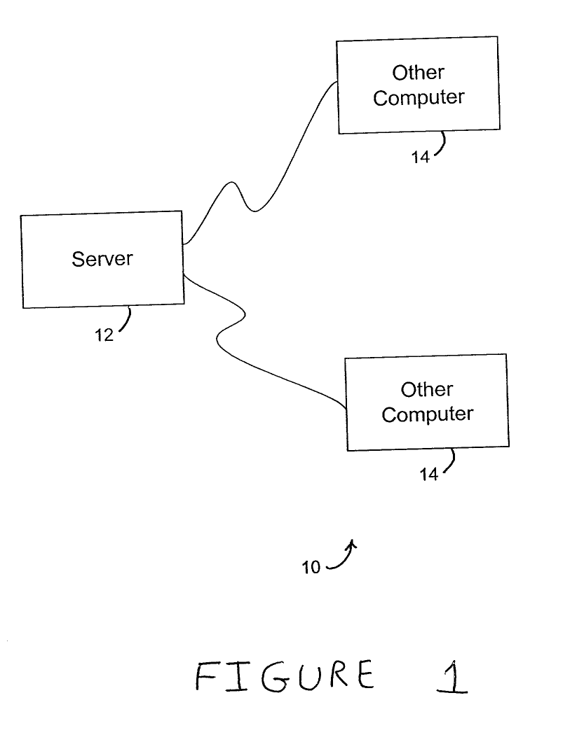

FIG. 1 illustrates an exemplary system 10 in accordance with one embodiment of the present invention. System 10 includes a computer configured as a server 12 and a plurality of other computers 14 coupled to server 12 to form a network. The network of computers may be local area networks (LAN) or wide area networks (WAN).

Server 12 is configured to aid in implementing a business model, described below, and includes web pages through which buyers and sellers of goods or commodities can access to buy, sell or bid on those goods and commodities. The web pages stored in server computer 12 can be accessed by a requester at any one of computers 14. In one embodiment, server 12 is coupled to computers 14 via a WAN or LAN. A user may dial-in or directly login to an Intranet or the Internet to gain access to server 12. Each computer 14 includes an interface for communicating with server 12. The interface allows a user to input data relating to the buying and selling of goods and commodities which are uploaded to server 12.

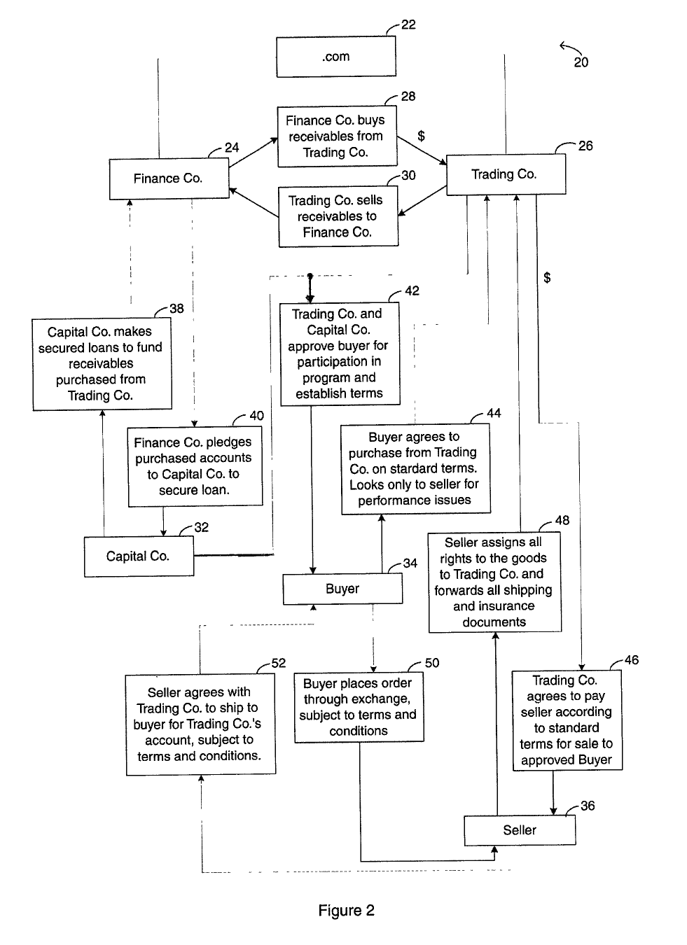

FIG. 2 is a chart 20 of a business model showing transactions and paths of the transactions according to the present invention. Chart 20 includes a parent company 22 and two wholly owned subsidiaries, finance subsidiary 24 and trading subsidiary 26. According to the business model, finance subsidiary 24 buys 28 receivables from trading subsidiary 26 and trading subsidiary 26 sells 30 receivables to finance subsidiary 24. The business model shown in FIG. 2 includes a capital company 32 which supplies capital to the business venture, a buyer 34 of the receivables and a seller 36 of the receivables.

As shown in FIG. 2 capital company 32 makes 38 secured loans to finance subsidiary 24 to fund receivables purchases from trading subsidiary 26. In return, finance subsidiary 24 pledges 40 purchased accounts to capital company 32 to secure the loan. Both trading subsidiary 26 and capital company 32 have to approve 42 buyer 34 for participation in the business model and also establish terms of participation followed by buyer 34. One established term is that buyer 34 agrees 44 to purchase from trading subsidiary 26 on standard terms and only holds seller 36 responsible for performance issues.

As to seller 36, trading subsidiary 26 agrees 46 to pay seller 36 according to standard terms for sale to approved buyer 34. In addition seller 36 assigns 48 all rights to the goods to trading subsidiary 26 and forwards all shipping and insurance documents to trading subsidiary 26. Buyer 34 places 50 orders, subject to terms and conditions. Seller 36 agrees 52 with trading subsidiary 26 to ship to buyer 34 for trading subsidiary's account, subject to agreed upon terms and conditions.

As described in FIG. 2, the method for executing and financing transactions of commodities as a parent company is accomplished by incorporating wholly owned subsidiary companies, such as financing company 24 and trading subsidiary 26. Financing company 24 is bankruptcy remote and is configured to buy 100 percent of the receivables from trading company 26 on a true sale basis with proceeds of secured revolving credit from capital company 32. Capital company 32 agrees to make loans to finance company 24 based on a borrowing base determined from the eligible purchased receivables previously sold to finance company 24 by trading company 26. The capital company loans are guaranteed by parent company 22. In addition, approval of seller participation according to a seller participation agreement and approval of buyer participation according to a buyer participation agreement facilitate implementation of the business model. Approval of buyers and sellers may be effected individually, through standardized scoring models, or through computer assisted or automated scoring and authentication routines.

Examples of seller participation agreements include, but are not limited to clauses such as, agreeing to sell goods to the trading subsidiary on the terms and conditions agreed, and agreeing to look only to the trading subsidiary for payment on terms agreed to with the trading subsidiary, the terms varying on the creditworthiness of the seller as determined by the parent company and a supplier of capital. Other clauses typically in seller participation agreements include agreeing to assign all of the rights in a shipment to the trading subsidiary, agreeing that the buyer has a right to enforce any claims for non-conformity of shipment and non-performance, agreeing to resolve any disputes with a buyer in accordance with a dispute resolution mechanism selected by the parent company, and agreeing to grant the trading subsidiary a security interest in seller's right to receive payment in order to secure seller's obligations under the participation agreement, whether the obligations are owed to either or both of the buyer or the trading subsidiary. Acceptance and implementation of standard terms may be by ancillary agreements or acceptance of an offer on standard terms by use of the computerized market through which the buyer/seller transaction is effected. Still other clauses typically in seller participation agreements include agreeing to assign the trading subsidiary receivables and rights to the financing subsidiary and the supplier of capital, agreeing to indemnify the trading subsidiary for all losses of whatever kind resulting from seller non-performance, and agreeing to waive any set-off rights the seller may have against the buyer or the trading subsidiary as applicable to any receivable held by the financing subsidiary.

Examples of buyer participation agreements include, but are not limited to clauses such as agreeing to pay 100 percent of the purchase price to the trading subsidiary for orders within an agreed time period by a method and at a place previously agreed to, agreeing to pay ancillary charges such as shipping, handling, insurance and taxes and agreeing to be subject to suspension for a specified period in the event of a dispute as to conformity of goods shipped, subject to obligation to pay at the end of the suspension period with interest if the dispute is not resolved in the buyer's favor. Other clauses typically in buyer participation agreements include agreement on timing of transfer of title and risk of loss, agreeing only to hold seller responsible for performance or conformity of goods, agreeing to provide security for the buyer's obligations, if deemed appropriate for approving buyer participation, agreeing to indemnify the trading subsidiary for all losses of any kind resulting from buyer non-performance, agreeing to waive any set-off rights the buyer may have against the seller or the trading subsidiary as applicable to any receivable held by the financing subsidiary, and agreeing to the assignment of the trading subsidiary receivables and rights to the financing subsidiary and a supplier of capital.

As described above, the business model encourages the development of E-commerce by developing a business structure whereby a parent company can insulate assets by separating company control and economic interests. While the invention has been described in terms of various specific embodiments, those skilled in the art will recognize that the invention can be practiced with modification within the spirit and scope of the claims.

What is claimed is:

1. A method for executing and financing transactions of goods and commodities as a parent company, said method comprising the steps of:
incorporating a wholly owned financing subsidiary company and a wholly owned trading subsidiary company;
approving sellers to participate according to a seller participation agreement;
approving buyers to participate according to a buyer participation agreement; and
securing capital to facilitate financing through the financing subsidiary.

2. A method according to claim 1 wherein said step of approving sellers to participate further comprises the step of agreeing to sell goods to the trading subsidiary on terms and conditions as agreed.

3. A method according to claim 1 wherein said step of approving sellers to participate further comprises the step of agreeing to only hold the trading subsidiary responsible for payment on terms agreed to with the trading subsidiary.

4. A method according to claim 3 wherein said step of agreeing to look only to the trading subsidiary for payment on terms agreed to further comprises the step of varying the terms based on the creditworthiness of the seller.

5. A method according to claim 4 wherein said step of varying the terms based on the creditworthiness of the seller further comprises the step of determining the creditworthiness of the seller by the parent company and a supplier of capital.

6. A method according to claim 1 wherein said step of approving sellers to participate further comprises the step of agreeing to assign all of the rights in a shipment to the trading subsidiary.

7. A method according to claim 1 wherein said step of approving sellers to participate further comprises the step of agreeing that the buyer has a right to enforce any claims for non-conformity of shipment and non-performance.

8. A method according to claim 1 wherein said step of approving sellers to participate further comprises the step of agreeing to resolve any disputes with a buyer in accordance with a dispute resolution mechanism selected by the parent company.

9. A method according to claim 1 wherein said step of approving sellers to participate further comprises the step of agreeing to grant the trading subsidiary a security interest in seller's right to receive payment in order to secure seller's obligations under the participation agreement.

10. A method according to claim 1 wherein said step of approving sellers to participate further comprises the step of agreeing to assign the trading subsidiary receivables and rights to the financing subsidiary and the supplier of capital.

11. A method according to claim 1 wherein said step of approving sellers to participate further comprises the step of agreeing to indemnify the trading subsidiary for losses resulting from seller non-performance.

12. A method according to claim 1 wherein said step of approving sellers to participate further comprises the step of agreeing to waive any set-off rights the seller may have against the buyer or the trading subsidiary as applicable to any receivable held by the financing subsidiary.

13. A method according to claim 1 wherein said step of approving buyers to participate further comprises the step of agreeing to pay the purchase price to the trading subsidiary for orders within an agreed upon time period by a method and at a place previously agreed to.

14. A method according to claim 1 wherein said step of approving buyers to participate further comprises the step of agreeing to pay ancillary charges for at least one of shipping, handling, insurance and taxes.

15. A method according to claim 1 wherein said step of approving buyers to participate further comprises the step of agreeing to be subject to suspension for a specified period in the event of a dispute as to conformity of goods shipped.

16. A method according to claim 15 wherein said step of agreeing to be subject to suspension further comprises the step of being obligated to pay at the end of the suspension period.

17. A method according to claim 16 wherein said step of being obligated to pay further comprises the step of paying with interest if the dispute is not resolved in the buyer's favor.

18. A method according to claim 1 wherein said step of approving buyers to participate further comprises the step of agreeing to only hold seller responsible for performance or conformity of goods.

19. A method according to claim 1 wherein said step of approving buyers to participate further comprises the step of agreeing on a timing of transfer of title and risk of loss.

20. A method according to claim 1 wherein said step of approving buyers to participate according to a buyer participation agreement further comprises the step of agreeing to provide security for the buyer's obligations.

21. A method according to claim 1 wherein said step of approving buyers to participate according to a buyer participation agreement further comprises the step of agreeing to indemnify the trading subsidiary for losses resulting from buyer non-performance.

22. A method according to claim 1 wherein said step of approving buyers to participate according to a buyer participation agreement further comprises the step of agreeing to waive any set-off rights the buyer may have against the seller or the trading subsidiary as applicable to any receivable held by the financing subsidiary.

23. A method according to claim 1 wherein said step of approving buyers to participate according to a buyer participation agreement further comprises the step of agreeing to the assignment of the trading subsidiary receivables and rights to the financing subsidiary and a supplier of capital.

24. A system for executing and financing transactions of goods and commodities for a parent company through a wholly owned financing subsidiary and a wholly owned trading subsidiary, said system comprising:
at least one computer;
a server configured to approve sellers of goods and commodities according to a seller participation agreement and approve buyers of goods and commodities according to a buyer participation agreement;
a network connecting said at least one computer to said server; and
a user interface allowing a user to input and receive information relating to the buying and selling of the goods and commodities.

25. A system according to claim 24 wherein said server is further configured to facilitate securing of capital for a transaction through the financing subsidiary of the parent company.

26. A system according to claim 24 wherein said server configured to facilitate sales of goods and commodities to the trading subsidiary of the parent company according to agreed upon terms and conditions within the sellers participation agreement.

27. A system according to claim 24 wherein said server configured to, after a sale of goods or commodities, notify the trading subsidiary for payment on terms agreed to with the seller.

28. A system according to claim 27 wherein said server configured to vary the terms based on a creditworthiness of the seller.

29. A system according to claim 28 wherein said server configured to determine the creditworthiness of the seller based on input to the server by at least one of the parent company and a supplier of capital.

30. A system according to claim 24 wherein said server configured to accept input from a seller agreeing to assign all rights in a shipment to the trading subsidiary.

31. A system according to claim 24 wherein said server configured to accept input from a seller agreeing that a buyer has a right to enforce any claims for non-conformity of shipment and non-performance.

32. A system according to claim 24 wherein said server configured to accept input from sellers agreeing to resolve any disputes with a buyer in accordance with a dispute resolution mechanism selected by the parent company.

33. A system according to claim 24 wherein said server configured to accept input from sellers agreeing to grant the trading subsidiary a security interest in seller's right to receive payment in order to secure seller's obligations under the participation agreement.

34. A system according to claim 24 wherein said server configured to accept input from sellers agreeing to assign the trading subsidiary receivables and rights to the financing subsidiary and the supplier of capital.

35. A system according to claim 24 wherein said server configured to accept input from sellers agreeing to indemnify the trading subsidiary for losses resulting from seller non-performance.

36. A system according to claim 24 wherein said server configured to accept input from sellers agreeing to waive any set-off rights the seller may have against a buyer or the trading subsidiary as applicable to any receivable held by the financing subsidiary.

37. A system according to claim 24 wherein said server configured to accept input from buyers agreeing to pay the purchase price to the trading subsidiary for orders within an agreed upon time period by a method and at a place previously agreed to.

38. A system according to claim 24 wherein said server configured to accept input from buyers agreeing to pay ancillary charges of at least one of shipping, handling, insurance and taxes.

39. A system according to claim 24 wherein said server configured to accept input from buyers agreeing to be subject to suspension for a specified period in the event of a dispute as to conformity of goods shipped.

40. A system according to claim 39 wherein said server configured to accept input from buyers agreeing to an obligation to pay at the end of the suspension period with interest if the dispute is not resolved in the buyer's favor.

41. A system according to claim 24 wherein said server configured to accept input from buyers agreeing on a timing of a transfer of title and risk of loss.

42. A system according to claim 24 wherein said server configured to accept input from buyers agreeing to only hold seller responsible for performance or conformity of goods.

43. A system according to claim 24 wherein said server configured to accept input from buyers agreeing to provide security for the buyer's obligations.

44. A system according to claim 24 wherein said server configured to accept input from buyers agreeing to indemnify the trading subsidiary for losses resulting from buyer non-performance.

45. A system according to claim 24 wherein said server configured to accept input from buyers agreeing to waive any set-off rights the buyer may have against a seller or the trading subsidiary as applicable to any receivable held by the financing subsidiary.

46. A system according to claim 24 wherein said server configured to accept input from buyers agreeing to the assignment of the trading subsidiary receivables and rights to the financing subsidiary and a supplier of capital.

47. A system according to claim 24 wherein said server is configured to allow a user to input data via the Internet.

48. A system according to claim 24 wherein said server is configured to receive user data via an Intranet.

49. A system according to claim 24 wherein said network is one of a wide area network and a local area network.
